(19) United States
(12) Patent Application Publication
(10) Pub. No.: US 2012/0316937 A1
(43) Pub. Date: Dec. 13, 2012

(54) Method and Apparatus For Affiliate Marketing

(76) Inventor: Amir LOTAN, Tel Aviv (IL)

(21) Appl. No.: 13/156,569

(22) Filed: Jun. 9, 2011

(51) Int. Cl. G06Q 30/00; G06Q 40/00

(52) U.S. Cl. 705/14.16; 705/39

(57) ABSTRACT

The subject matter discloses a method and apparatus for affiliate marketing; the method comprising the steps of: receiving a link of a retailer site from a recommender (210); generating a new link; sending the new link to the recommender for distribution to a plurality of computerized network users (230); and receiving a first purchase report message from the retailer site; further wherein said step of generating said new link comprises attaching an identification of an affiliate and an identification of the recommender to the link and wherein the first purchase report message comprises the identification of the recommender; wherein said identification of the recommender is extracted from the new link; thereby updating the account balance of the recommender with a percentage from an affiliate fee (240).

### FIELD OF THE INVENTION

The present invention generally relates to the interne computerized network and in particular to affiliate marketing

### BACKGROUND OF THE INVENTION

PCT application Wo2008066352 to Joo Jin Yong, discloses an affiliate marketing service system and method. The affiliate marketing service system includes an affiliate marketing server operated by an affiliate marketing company, an affiliate shopping mall server operated by an affiliate shopping mall company that enters into an affiliate marketing contract with the affiliate marketing company and provides a predetermined portion of a selling price to the affiliate marketing company, and one or more customer terminals configured to connect with the affiliate marketing server and the affiliate shopping mall server. The customer terminal includes an interface device that is provided with a Uniform Resource Locator (URL) detection module for detecting a URL of a website accessed by a customer and sending a result of the detection to the affiliate marketing server. The affiliate shopping mall server includes a purchasing information detection module. The affiliate marketing server includes an affiliate detection module and a service management module.

US200100372505 application to Joao, Raymond Anthony discloses an apparatus and method for effectuating an affiliated marketing relationship, including a receiver for allowing a user to access the apparatus via a content provider computer, a processor for processing a transaction entered into by the user and a merchant associated with the apparatus, wherein the processor identifies the content provider referring the user to the apparatus, and further wherein the processor calculates at least one of a commission and a referral fee due to the content provider, and further wherein the processor generates a transaction notification report containing information regarding the occurrence of the transaction and the at least one of a commission and a referral fee, and a transmitter for transmitting the transaction notification report to a communication device associated with the content provider.

PCT application WO2007025020 to Humphries, Wofford, F., discloses a method of affiliate marketing provides inbound affiliate link credit without coded URLs. Affiliate web sites link directly to merchant web sites, so that all of a merchant site's affiliates potentially contribute to its inbound link credit. The merchant web server parses incoming web page requests, and extracts the referrer. The merchant web server, directly or via an affiliate computerized network manager, consults a database of affiliate web sites to determine whether the referrer is an authorized affiliate. If so, the affiliate is credited for the traffic, and may additionally be credited for user activity at the merchant site. The affiliate computerized network manager writes a cookie to the user terminal to further track the user through the affiliate computerized network. The method reduces or eliminates cookie hijacking and other forms of affiliate fraud, and may be used to track non-affiliate referring web sites

Affiliate marketing is a marketing practice in which a business rewards one or more affiliates fee for each visitor or customer brought about by the affiliate's own marketing efforts. Examples include rewards sites, where users are rewarded with cash or gifts, for the completion of an offer, and the referral of others to the site. The industry has four core players: the merchant (also known as ‘retailer’ or ‘brand’), the computerized network, the publisher (also known as ‘the affiliate’), and the customer. The market has grown in complexity to warrant a secondary tier of players, including affiliate management agencies, super-affiliates and specialized third parties vendors. Affiliate marketing using one website to drive traffic to another is a form of online marketing.

### SUMMARY OF THE INVENTION

One exemplary embodiment of the disclosed subject matter is a method for affiliate marketing; the method comprising the steps of a. receiving a link of a retailer site from a recommender (210); b. generating a new link c. sending the new link to the recommender for distribution to a plurality of computerized network users (230); and d. receiving a first purchase report message from the retailer site; further wherein said step of generating said new link comprises attaching an identification of an affiliate and an identification of the recommender to the link and wherein the first purchase report message comprises the identification of the recommender; wherein said identification of the recommender is extracted from the new link; thereby updating the account balance of the recommender with a percentage from an affiliate fee (240).

According to some embodiments, the method further comprising extracting the identification of the recommender from the first purchase report message and directing a second purchase report message to the recommender for updating the recommender on the purchase; wherein the directing is according to the extracted recommended identification.

According to some other embodiments, the method further comprising the updating of the account balance of the recommender.

According to some other embodiments, the method further comprising the step of embodiments generating a shorten link from the new link; thereby for facilitating an access to the retailer site.

Another exemplary embodiment of the disclosed subject matter is an apparatus for affiliate marketing; the apparatus comprising: receiving unit (310) configured for receiving a link of a retailer site from a recommender and for receiving a first purchase report message from the retailer site; a processor (320) configured for generating a new link; and a transmitter unit (330) configured for sending the new link to the recommender for being distributed to a plurality of computerized network users; wherein said processor is further configured for attaching an identification of an affiliate and an identification of a recommender to the new link and wherein the first purchase report message comprises the recommender identification that is extracted from the new link.

According to some embodiments, the processor is further configured for extracting the identification of the recommender from the first purchase report message and for directing a second purchase report message to the recommender; wherein the directing is according to the extracted recommended identification.

According to some other embodiments the processor is further configured for updating an account balance of the recommender.

Another exemplary embodiment of the disclosed subject matter is a computer program placed on a magnetic readable media for coupling between computerized network users, the computer program comprising a. a first program instruction for receiving a link of a retailer site from a recommender (210); a second program instruction for generating a new link; a third program instruction for sending the new link to the recommender for distribution to a plurality of computerized network users (230); and a fourth program instruction for receiving a first purchase report message from the retailer site; further wherein said step of generating said new link comprises attaching an identification of an affiliate and an identification of the recommender to the link and wherein the first purchase report message comprises the identification of the recommender; wherein said identification of the recommender is extracted from the new link; thereby updating the account balance of the recommender with a percentage from an affiliate fee (240); wherein the first, second third and fourth program instructions are stored on a computer readable medium

### BRIEF DESCRIPTION OF THE DRAWINGS

In order to better understand the invention and its implementation in a practice, a plurality of embodiments will now be described, by way of non-limiting example only, with reference to the accompanying drawings, in which

FIG. 1 shows a flowchart diagram of a process for receiving a reward by referring one or more computerized network users to a retailer site, in accordance with some exemplary embodiments of the disclosure.

FIG. 2 shows an exemplary method for affiliate marketing, in accordance with some exemplary embodiments of the disclosure;

FIG. 3 shows an exemplary block diagram of an apparatus for affiliate marketing, in accordance with some exemplary embodiments of the disclosure; and

FIG. 4 shows an exemplary block diagram of affiliate marketing platform, in accordance with some exemplary embodiments of the disclosure;

### DESCRIPTION OF PREFERRED EMBODIMENTS

The following description is provided, along all chapters of the present invention, so as to enable any person to make use of said invention and sets forth the best modes contemplated by the inventor of carrying out this invention. As is customary, it will be understood that no limitation of the scope of the invention is thereby intended. Further modifications will remain apparent to those skilled in the art, since the generic principles of the present invention have been defined specifically to provide means and methods for an affiliate marketing platform.

The term “affiliate marketing platform” refers hereinafter to a platform that provides a user the ability to recommend a link to a retailer site with which the platform has affiliate relations to one or more network users and to receive a percentage from the affiliate fee (reward) when a purchase is performed by one of the network users.

The term “affiliate relations” refers hereinafter to a relation between two sites in which a first site receives monetary rewards, also termed as “affiliate fee” from the second site. The monetary reward is paid when the network user access the second site via a link that was made accessable by him through the first site. In some cases the reward is paid when the network user actually purchases a product or a service through the second site.

The term “computerized network” refers hereinafter to a network which is controlled by one or more computers. Such a network may be, for example, the interne, cellular network, intranet, Public Switch Telephone Network and the like.

The terms “recommender” and “platform user” used interchangeably in the present invention, refers hereinafter to a user of the affiliate marketing platform who uses the platform for recommending a site or a product to other people via the computerized network in order to get a percentage from the affiliate fees. The recommendation may be done by propagating a link to the site via the computerized network, by for example email, SMS, Twitter, Facebook and the like. Such a recommender may be rewarded without having to be in direct contact with the affiliate.

The term “shortened” refers to abbreviating a link whilst retaining it's specificity, or rendering the link easier or more convenient to generate whilst still maintaining the link's specificity.

The computerized network enables computer network users, such as friends, acquaintances, bloggers, site owners, non experts, casual product users who have had a worthwhile experience with the product/service, experts or people having an experience of using a product or a service, people having positive opinion regarding a product or service, to recommend the product or service to other people via the network. Many recommenders would like to get a financial reward from the recommended retailer for providing such an advice.

Such recommenders may not have affiliate contract with the site they wish to recommend and thus there is a need for a technical solution for the problem of rewarding such recommenders. Thus one technical problem dealt with by the present disclosure is to automatically identify the recommender of a retailer site; wherein the indemnification is for crediting the recommender.

One technical solution is a method for receiving from the platform user a link to a retailer site, and for generating a second link wherein the second link includes the affiliate identification and the identification of the user and for returning the second link to the platform user to be propagated by the platform user through the computerized network. The propagation can be via email, Social networks such as Facebook, SMS message and the like. The method further comprises receiving a purchase report from the retailer site; extracting the identification of the user from the purchase report for identifying the user and crediting the user account. Such a solution enables the users to receive affiliate fee from a site without the need for having an affiliate contract with the site. The affiliate fee may be paid to the users' account. The user may withdraw the whole amount of money or portions from the amount of money from this account at any time.

In some exemplary embodiments, the user may request more information from the system and may receive recommendations for specific product or for one or more other products according to the field of interest.

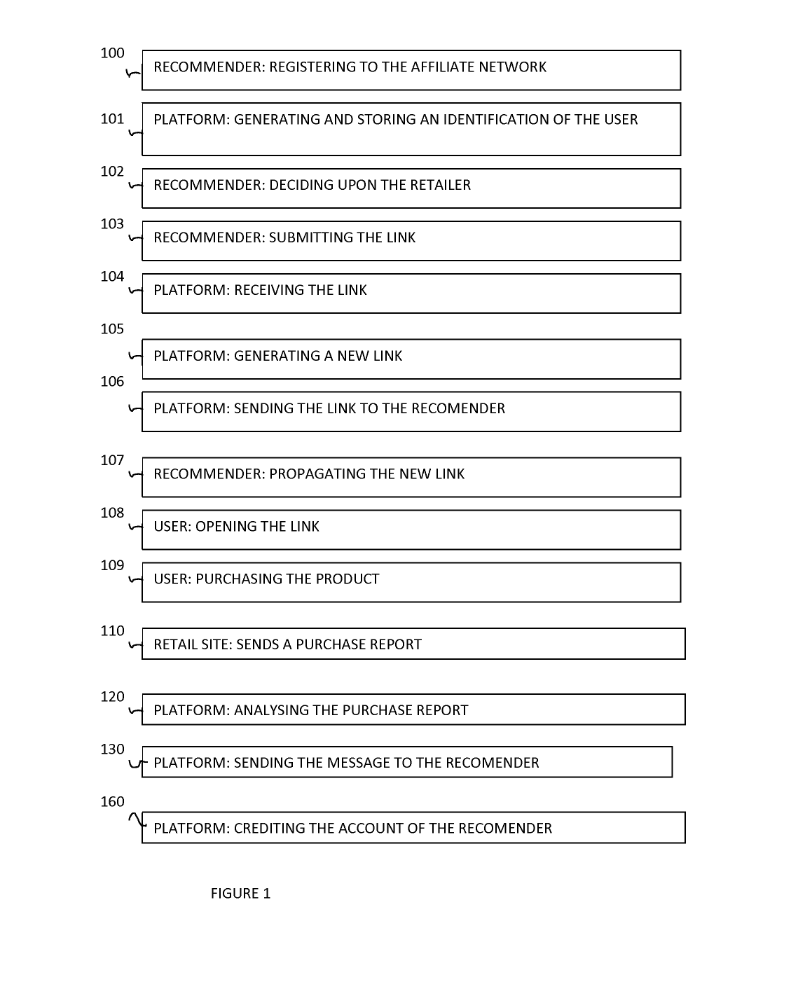

Reference is made now to FIG. 1 which shows a flowchart diagram of a process for receiving a reward by referring one or more computerized network users to a retailer site, in accordance with some exemplary embodiments of the disclosure.

At 100, the recommender registers to the affiliate marketing platform.

At 101, the affiliate marketing platform generates a unique identification of the user and stores this user identification in a storage. The affiliate marketing platform stores other information related to the user. Such information includes email address, account and the like.

At 102, the recommender determines the retailer about the product or service that he would like to recommend to one or more computerized network users. The recommender further finds and transfers or otherwise fetches the link to the product or the service. Finding the product or the service can be done by browsing the interne commercial sites, such as affiliate-store.com, or by using the affiliate marketing platform. The recommender may choose the product or service according to parameters such as price, quality, features and the like.

At 103, the recommender submits the link of the product or service to the affiliate marketing platform. For example, if the product is a play station 3 and the retailer is affiliate-store.com, then the submitted link may be http://www.affiliate-store.com/PlayStation. or any other URL format that Affiliate-store would provide.

At 104, the link is received and is analyzed by the affiliate marketing platform.

At 105, the affiliate marketing platform generates a new link by attaching affiliate identification and an identification of the user to the link. For example, if the received link is http://www.affiliate-store.com/PlayStation, it is transformed to http://www.affiliate-store.com/PlayStation?affiliation id=1234&user id=54.

AT 106, the new link is sent to the recommender. In some embodiments, a shortened link instead of the new link such as, for example: http://affiliate-marketing-platform.com/playstation is sent to the recommender.

At 107, the recommender propagates the new link to one or more computerized network users. The propagating can be done, for example, by Email, by Mobile text, Facebook, Twitter or any other social media and the like.

At 108, one of the computerized network users to which the link was sent opens the link.

At 109, the user purchases the product or service that is referred by the link.

At 110, a purchase report is sent from the retailer site to the affiliate marketing platform. The report includes the amount of money that is credited to the affiliate as a result of the purchase. In some embodiments report is sent to the affiliate marketing platform when the user opens the link. The report includes the identification of the recommender. In some embodiments, the report includes the link that was propagated by the recommender.

At 120, the purchased report is analyzed by the affiliate marketing platform and the identification of the recommender is extracted from the report. Additionally the amount of money that is credited to the recommender is calculated. For example, if the affiliate is credited with $20 for the purchase and the affiliate has an agreement with the recommender for 10% of the credit, then the recommender will be credited with $2.

At 130, a message may be sent to the recommender. The message notifies the recommender about the purchase and about the monetary reward.

At 140, the account of the recommender is credited. Crediting may be done by automatically transferring money to the recommender bank account or by holding the money an account of the affiliate. In the latter case, the recommender may receive the money upon demand or, when the amount exceeds a certain threshold, or after a certain time elapse, (for example, after a month or at a beginning of a month) or a combination thereof. Once the user is credited, the user may withdraw the money at any time. The user may withdraw a portion of the money as well as the whole amount.

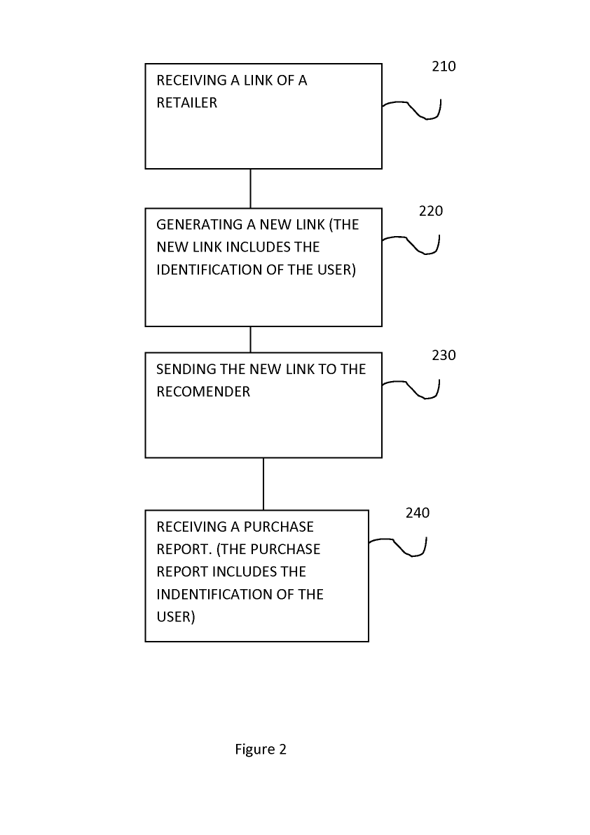

FIG. 2 shows a method for affiliate marketing, in accordance with some exemplary embodiments of the disclosure.

At 210, a link of a retailer site is received from a recommender. For example, if the recommender wishes to recommend a play station from affiliate-store.com the link may be http://www.affiliate-store.com/PlayStation.

At 220, a new link is generated by attaching the identification of an affiliate and the identification of the recommender to the link. The identification of the affiliate is used by the retailer site in order to reward the affiliate when a purchase is performed. The identification of the recommender is used by the affiliate in order to share a percentage of the affiliate fee with the recommender. An example of the attached link may be http://www.affiliate-store.com/PlayStation?affiliation id=1234&user id=54. In some exemplary embodiments a shortened link is also generated for facilitating the usage of the link. The shortened link is a redirection of the new link. An example of a shortened link may be http://affiliate-marketing-platform.com/playstation.

At 230, the new link is sent to the recommender for being distributed to a plurality of computerized network users. The new link is distributed via the computerized network, for example via Email message, Facebook and the like. In some exemplary embodiments the shortened link is distributed.

At 240, a purchase report message is received from the retailer site as a result of a purchase performed by one of the users to which the new link was sent by the recommender. The first purchase report message includes the identification of the recommender which is extracted from the new link. The identification of the recommender is extracted from the purchase report message for updating the account balance of the recommender with a percentage from an affiliate fee. The affiliate fee is received from the retailer site for rewarding the affiliate marketing platform on the purchase. This fee is shared with the recommender.

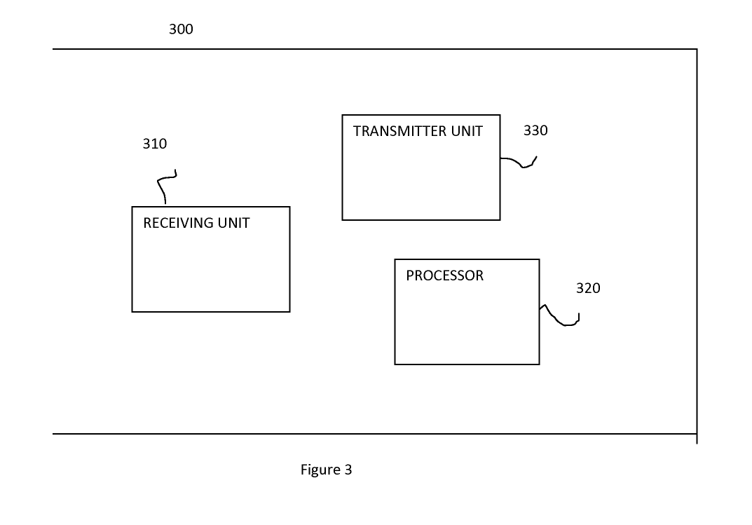

FIG. 3 shows a block diagram of an apparatus for affiliate marketing, in accordance with some exemplary embodiments of the disclosure. According to some embodiments of the disclosed subject matter, apparatus 300 includes a receiving unit 310, a processor 320 and a transmitting unit 330.

The receiving unit 310 is configured for receiving a link of a retailer site from a recommender and for receiving a purchase report message from the retail site.

The processor 320 is configured for generating a new link by attaching an identification of an affiliate and an identification of a recommender to the link. The processor 320 is further configured for extracting the identification of the recommender from the purchase report message and for generating a purchase report message for notifying the recommender about the purchase and about the reward to which he is entitled.

The transmitter unit 330 is configured for sending the new link to the recommender for being distributed to a plurality of computerized network users.

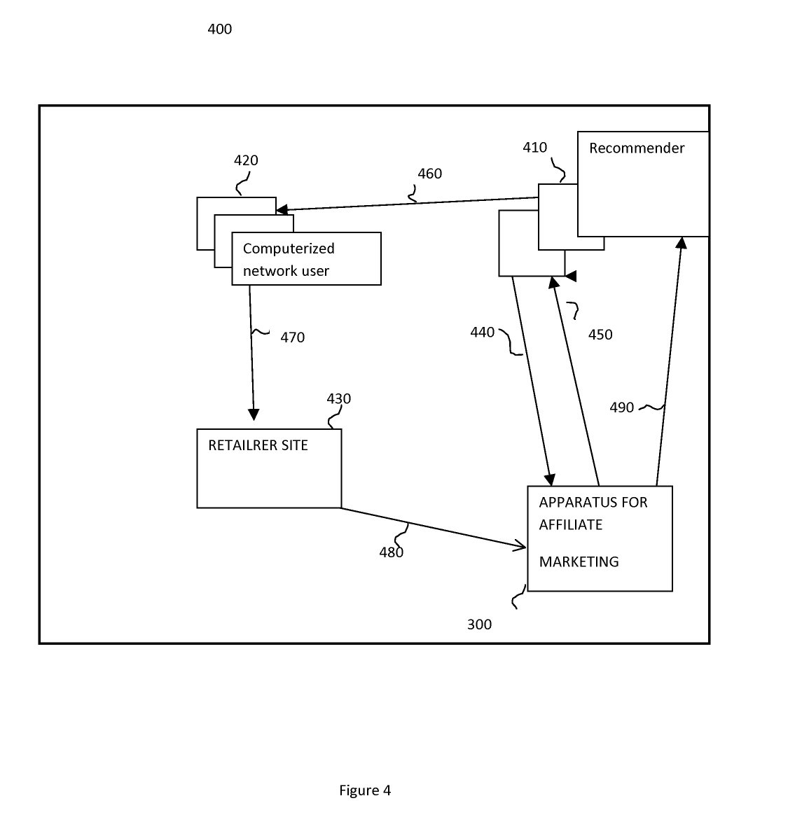

FIG. 4 shows a block diagram of an affiliate marketing platform, in accordance with some exemplary embodiments of the disclosure.

Affiliate marketing platform 400 comprises an apparatus for affiliate marketing 300, at least one recommender 410, at least one computerized network user 420 and at least one retail site 430.

The arrow 440 represents a link to a product or a server in the retailer site 430 sent by the recommender 410 to the apparatus for affiliate marketing 300.

The arrow 450 represents a new link that includes the identification of the affiliate and the identification of the recommender. The new link is sent from the apparatus for affiliate marketing 300 to the recommender 410.

The arrow 460 represents the new link that is sent from the recommender 410 to the at least one computerized network user 420. The new link is sent for recommending the at least one computerized network user 420 about the product or service.

The arrow 470 represents a linkage from the at least one computerized network user 420 to the retailer site 430. The linkage is generated as a result of opening the new link by the at least one computerized network user 420.

The arrow 480 represents the purchase report that is sent from the retailer 430 to the apparatus for affiliate marketing 300. The purchase report notifies about a purchase that was done by the user 320.

The arrow 490 represents the purchase report that is sent from the apparatus for affiliate marketing 300 to the recommender 410. The purchase report notifies the recommender 410 about the purchase and about the reward to which he is entitled.

1. A method for affiliate marketing; the method comprising the steps of:
a. receiving a link of a retailer site from a recommender (210);
b. generating a new link; wherein said step of generating said new link comprises attaching an identification of an affiliate and an identification of the recommender to the link.

2. The method of claim 1; further comprises the step of sending the new link to the recommender for distribution to a plurality of computerized network users (230).

3. The method of claim 1; further comprises the step of receiving a first purchase report message from the retailer site; wherein said first purchase report message comprises the identification of the recommender; wherein said identification of the recommender is extracted from the new link for updating the account balance of the recommender with a percentage from an affiliate fee (240).

4. The method of claim 1; further comprising extracting the identification of the recommender from the first purchase report message and directing a second purchase report message to the recommender for updating the recommender on the purchase; wherein the directing is performed according to the extracted recommended identification.

5. The method of claim 1, further comprising an updating of the account balance of the recommender.

6. The method of claim 1, further comprising the step of generating a shortened link from the new link; thereby facilitating an access to the retailer site.

7. The method of claim 5, further comprises withdrawing money from the account following receiving a withdrawal request from the recommender;
wherein the withdrawing is for the whole amount of the affiliate fee or for a portion of the amount of the affiliate fee.

8. An apparatus for affiliate marketing; the apparatus comprising:
a) a receiving unit (310) configured for receiving a link of a retailer site from a recommender and for receiving a first purchase report message from the retailer site; and
b) a processor; wherein said processor is further configured for attaching an identification of an affiliate and an identification of a recommender to the new link (320).

9. The apparatus of claim 8, further comprises a transmitter unit (330) configured for sending the new link to the recommender for being distributed to a plurality of computerized network users; wherein the first purchase report message comprises the recommender identification that is extracted from the new link.

10. The apparatus of claim 8; wherein the processor is further configured for extracting the identification of the recommender from the first purchase report message and for directing a second purchase report message to the recommender; wherein the directing is according to the extracted recommended identification.

11. The apparatus of claim 8, wherein the processor is further configured for updating an account balance of the recommender.

12. A computer program placed on a magnetic readable media for coupling between computerized network users, the computer program comprising:
a. a first program instruction for receiving a link of a retailer site from a recommender (210);
b. a second program instruction for generating a new link
c. a third program instruction for sending the new link to the recommender for distribution to a plurality of computerized network users (230); and
d. a fourth program instruction for receiving a first purchase report message from the retailer site; further wherein said step of generating said new link comprises attaching an identification of an affiliate and an identification of the recommender to the link and wherein the first purchase report message comprises the identification of the recommender; wherein said identification of the recommender is extracted from the new link; thereby updating the account balance of the recommender with a percentage from an affiliate fee (240); wherein the first, second third and fourth program instructions are stored on a computer readable medium.

13. A method for crediting a recommender for an affiliate transaction; the method comprises the steps of:
a. receiving a link of a retailer site from a recommender (210);
b. generating a new link
c. sending the new link to the recommender for distribution to a plurality of computerized network users (230);
d. receiving a first purchase report message from the retailer;
e. crediting an account of the recommender wherein the crediting comprises one member of the group consisting of automatically and instantly transferring money to the recommender bank account, transferring the money upon demand of the recommender, transferring the money when the amount exceeds a certain threshold and transferring the money after a certain time elapse.
